(19) United States
(12) Patent Application Publication
(10) Pub. No.: US 2017/0213166 A1
(43) Pub. Date: Jul. 27, 2017

(54) ONLINE PROFIT DISTRIBUTING SYSTEM IN ACCORDANCE WITH TRANSLATION AND PUBLICATION

(71) Applicant: Jun Young LEE, Seoul (KR)

(72) Inventor: Jun Young LEE, Seoul (KR)

(21) Appl. No.: 15/481,417

(22) Filed: Apr. 6, 2017

Related U.S. Application Data
(63) Continuation of application No. PCT/KR2015/009804, filed on Oct. 6, 2015.

(30) Foreign Application Priority Data
Jan. 29, 2015 (KR) 10-2015-0013926

(51) Int. Cl. G06Q 10/06; G06F 17/28; G06Q 40/06

(52) U.S. Cl. CPC G06Q 10/0631; G06Q 40/06; G06F 17/289

(57) ABSTRACT

Disclosed is a system that may distribute the profit obtained through translation and publication by allowing a platform operator, a writer, a translator, and a portal site to cooperate with each other. The inventive concept relates to a system that allows an investment of an investor in a work determined to have a high possibility of being sold. A contract letter of commitment for distribution of a profit made by a management company, a writer, a translator, and a portal site is written, stored, and managed.

### CROSS-REFERENCE TO RELATED APPLICATIONS

The present application is a continuation of International Patent Application No. PCT/KR2015/009804 filed on Oct. 6, 2015, which is based upon and claims the benefit of priority to Korean Patent Application No. 10-2015-0013926 filed on Jan. 29, 2015. The disclosures of the above-listed applications are hereby incorporated by reference herein in their entirety.

### BACKGROUND

Embodiments of the inventive concept described herein relate to an online profit distributing system in accordance with translation and publication.

More particularly, embodiments of the inventive concept relate to a system that may distribute the profit obtained through translation and publication by allowing a platform operator, a writer, a translator, and a portal site to cooperate with each other.

Embodiments of the inventive concept also relates to a system that allows an investment of an investor in a work determined to have a high possibility of being sold.

As a related technology, an online service method and a system for translation and publication in a joint purchase method is disclosed in Korean Patent Application Publication No. 2000-0072164.

The published technology provides a service method that uses an internet and an online publication system to provide a bibliography of previously published foreign books or abstract information to the internet by using a book list information system and allow service users to easily approach the book list information in order to order the service, thereby accurately predicting demands on the service users through an internet order system, executing translation and editing that ensure high quality by contacting the service users even during a manufacturing process, and providing the translation work in a form of a diskette, an optical medium (CD-ROM), an E-book, or a book.

However, the conventional technology is only a technology related to translation, editing, and publication work according to the prediction of the demands and is insufficient as a system for manufacturing an excellently translated work as a publication, and promoting the translated work to improve profit by securing a wide range of readers.

### PRIOR TECHNICAL DOCUMENT

Korean Patent Application Publication No. 2000-0072164

### SUMMARY

Accordingly, the inventive concept is made in an effort to improve the problems related to conventional translation and publication using online, and provides an online profit distributing system in accordance with translation and publication that allows a platform operator, a writer, a translator, and a portal site to cooperate with each other to distribute a profit obtained through translation and publication.

The inventive concept also provides an online profit distributing system in accordance with translation and publication that allows an investor to make an investment to a work that is determined to have a high possibility of being sold.

The inventive concept also provides an online profit distributing system in accordance with translation and publication that allows a translator to receive translation costs invested by an investor.

The other objects of the inventive concept will be inferred from the following contents.

In accordance with an aspect of the inventive concept, there is provided an online profit distributing system in accordance with translation and publication. The online profit distributing system includes a management platform that registers a work in association with a writer, a translator, and a portal site, translates the work, manages publication, promotion, and sales of the translated work, and manages distribution of a profit to the writer, the translator, and the portal site. The management platform manages a writer terminal in which the work is registered, requests a translation on the work registered in the management platform from a translator terminal through the writer terminal and receive a translation from the translator terminal, receives a request for selecting a work that is suitable for performance of translation by the translator from the one or more registered works, from the translator terminal, and invites readers for the translation after the translation by the translator is completed and perform sales of the translation in association with a portal site. The management platform and the portal site share a profit for the sales or subscription of the translation generated by the portal site.

The management platform may receive a request for investment from an investor terminal that supports translation costs for the work registered in the management platform and may manage distribution of the profit of the translation, wherein a portion of the profit is distributed to an investor.

The management platform may receive at least one of a past translation record, a translation ability, a percentage of royalties intended to be distributed as translator information from the translator terminal and may provide the translator information to the writer terminal for comparison of the translator by the writer.

When a plurality of translators apply for the translation, a specific translator may be selected based on the translator information of the translators from the writer terminal.

The management platform may provide a promotion activity through at least one of an SNS, a blog, and an internet cafe.

The translator information may further include agreement of advanced payment of translation costs.

The management platform may receive a request from the investor terminal, and provide writer information including at least one of sales records and sales profits of previous works of writers of works registered in the management platform and whether similar works in the same genres as those of the registered works from the management platform hits, to the investor terminal. The writer information may be used for selecting a work that is an investment target by the investor.

If receiving an investment of translation costs for a specific work from the investor terminal, the management platform may provide an investment support result to the writer terminal.

When investment of translation costs of the registered specific work by the investor is supported without an approval of the writer, the management platform may accommodate the investment support result received from the investor terminal as it is, apply the invest support result later when the royalties of the writer, the translator, and the investor are distributed.

The management platform may pay translation costs to the translator in advance through the investment support result, and provide a profit of the translator, among the royalty profit of the translation, to the investor.

According to the online profit distributing system in accordance with translation and publication, because a management company, a writer, a translator, and a portal site may cooperate with each other to distribute a profit obtained through translation and publication, a quality of translation may be improved and advancement to the abroad publication market through translation may be activated, and the sales profit may be maximized by an advertising/promotion effect.

Further, according to the online profit distributing system in accordance with translation and publication, because the investor may make an investment to a work that is determined to have a high possibility of being sold, a translation of an excellent quality may be obtained by more stably securing a capital source.

Furthermore, according to the online profit distributing system in accordance with translation and publication, because the translator may receive translation cots invested by the investor in advance, the translator may produce a translation of a high quality without worrying about translation costs not being payed.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual view of an online profit distributing system in accordance with translation and publication according to an embodiment of the inventive concept;

FIG. 2 is a system diagram technically illustrating FIG. 1;

FIG. 3 is a conceptual view of an online profit distributing system in accordance with translation and publication according to another embodiment of the inventive concept, the online profit distributing system including an investor;

FIG. 4 is a system diagram technically illustrating FIG. 2;

FIG. 5 is a flowchart illustrating operations of the online profit distributing system in accordance with translation and publication according to the first embodiment of the inventive concept; and

FIG. 6 is a flowchart illustrating operations of the online profit distributing system in accordance with translation and publication according to the second embodiment of the inventive concept.

### DETAILED DESCRIPTION

Hereinafter, exemplary embodiments of the inventive concept will be described in detail with reference to the accompanying drawings.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

The inventive concept may be variously modified and may have various embodiments, and it should be understood that the inventive concept includes all changes, equivalents, and replacements included in the spirit and technical scope of the inventive concept.

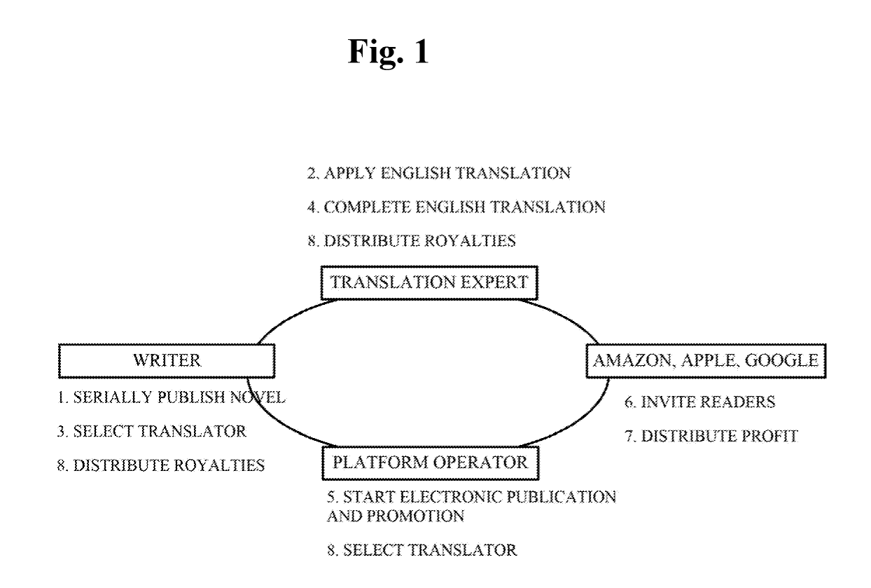

As illustrated in FIG. 1, an online profit distributing system in accordance with translation and publication according to an embodiment of the inventive concept is realized such that a platform operator (a management company), a writer, a translator (or a translation expert), and a portal site (Amazon, Apple, or Google) are associated with each other to cooperate with each other.

The platform operator is a means for controlling the system according to the inventive concept as a whole, and registers a work such that the work of the writer may be translated. The work includes a novel, a poem, a scenario, and a cartoon, and is not limited thereto.

The platform operator registers and manages personal data of a writer and a translation expert in advance. However, in the case of a rookie writer and a rookie translation expert, a work may be registered as a new one, and a translation may be newly applied for and personal data may be registered at the same time.

If the translation of the work is completed, the platform operator starts electronic publication and promotion by using the translation.

The platform operator signs a profit distributing contract with the writer, the translation expert, and the portal site. Here, the profit may be a profit that is distributed by specific percentages with reference to royalties based on circulations or sale proceeds or a sum obtained by subtracting manufacturing costs from total sale proceeds. The profit depends on a consultation between the platform operator, the writer, and the translator.

The platform operator distributes the sales profit through readers secured through the portal site, based on a contract between the platform operator and the portal site.

The writer registers a work, which is intended to be translated, in the platform operator, and selects a translator, who is to be introduced to translation work, from a plurality of translators who apply for the translation of the work.

The translator applies for the translation of the work of the writer, inform the platform operator of the completion of the translation if the translation is completed, and registers the translation.

The translator may apply for the translation after reading the work which the writer registered in the platform operator in consideration of the later royalty profit. Further, it is preferable that the translator applies for a work that may be translated with certainty, and for example, the translator may apply for translation of a work which he or she prefers.

The translator may consult the writer about the percentage of the royalties which he or she desired to receive through the platform operator, when applying for the translation. Further, the translator may directly consult the platform operator to determine the percentage of the royalties.

The translator provides the past translation record, the translation ability, the percentage of the royalties, and the like as information such that the writer may compare and select the translator.

The portal site cooperates with the platform operator to invite readers who are substantially the sources of the profit and may read or purchase the translated work. A method for inviting readers includes regular advertising, a popup window, and a notice, and the inventive concept is not limited thereto.

The online profit distributing system in accordance with translation and publication, which is configured in this way, is a business model that connects a writer and a translator to a platform operator for translation, publishes a translation, sells the translation through a portal site, and distributes the profit.

The basic process is a process in which, if the writer uploads his or her work to the platform operator, the translation experts apply for a translation of the work in consideration of his or her tastes and a possibility of sales.

The writer selects a translation expert in consideration of the past translation records, the translation abilities, the suggested percentages of royalties, and the like of the applied translators.

The selected translator proceeds translation and uploads the translation to the platform operator.

Accordingly, the platform operator makes an electronic publication through, for example, editing of the translation, such as editing of images, and sells the translation through portal sites such as Amazon, Apple, and Google.

If a sales profit and a royalty profit of the work sold through the portal sites are generated and the portal sites provide the profits to the platform operator, a specific profit is distributed to the portal operator and the portal sites at a specific ratio, and the platform operator distributes the royalties to the writer and the translator at a specific ratio.

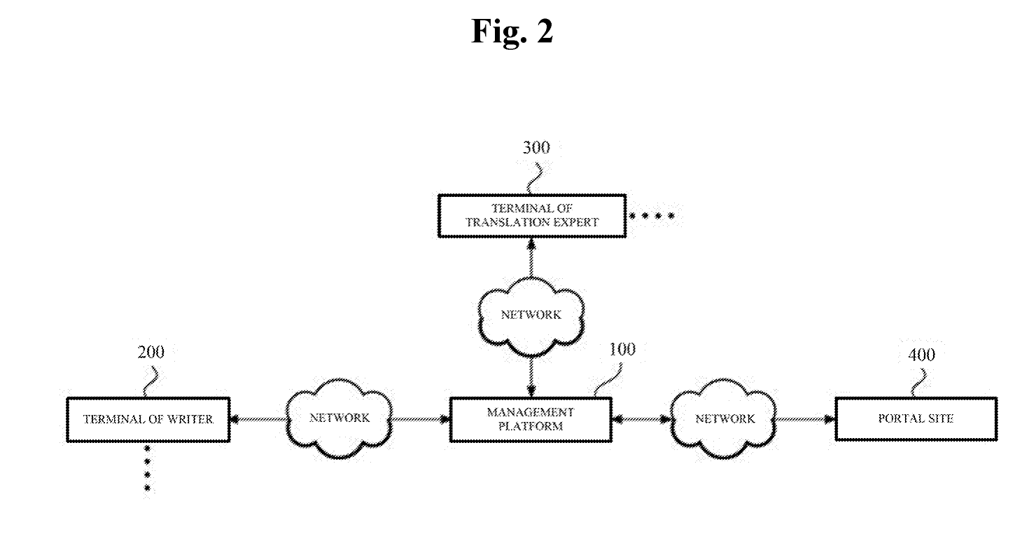

FIG. 2 is obtained by technically embodying the entire concept of the inventive concept illustrated in FIG. 1.

A management platform 100 is a means for collectively controlling the system.

The management platform 100 registers and manages personal data of a writer, which is input through a writer terminal 200, and registers a work which is intended to be translated to allow a translation expert to apply for translation.

The management platform 100 also registers and manages the personal data, which is input through a translation expert terminal 300, and registers the past translation record, the work history, the foreign language ability, the translation cost of the translation expert as information.

The management platform 100 also registers and manages a contract letter of commitment for distribution of a (royalty) profit that has been made with the writer and the translation expert. The percentage recorded in the registered contract letter of commitment for distribution of a profit is separately stored, and if a total profit is input when the profit is distributed later, the percentage is automatically determined and informed.

The management platform 1000 also registers and manages a contract letter of commitment made with the portal site 400.

The management platform 100 also, for example, may release a notice for a translation work, determine readers who have read the notice as preliminary purchasers, and deploy a promotion activity in a manner in which the subscribers who subscribed to the SNS, Facebooks, Twitters, Blogs, Cafes, which the readers subscribed, as preliminary purchasers.

Because the portal site 400 is a subject which invites readers and sells a work as the management platform 100 starts to perform electronic publication and promotion for the work, of which the translation has been completed, it contracts not distribution of royalties but distribution of the sales profit unlike the writer and the translation expert.

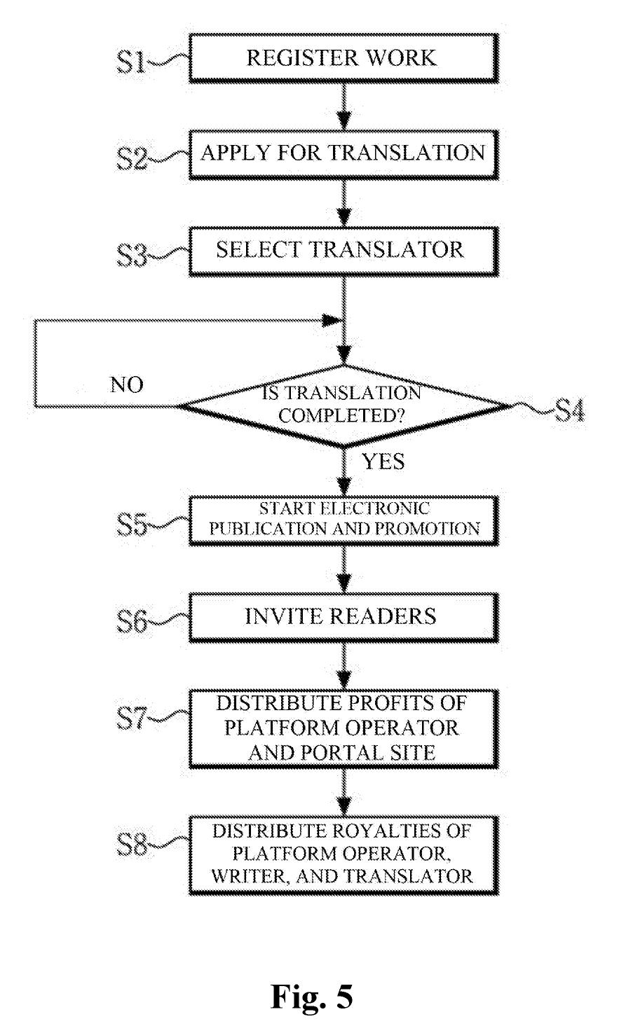

FIG. 5 illustrates an operation flow by the system of FIGS. 1 and 2.

A writer registers all or some of his or her works in the management platform 100 through the terminal 200. (S1)

The management platform 100 which recognized the situation notices the situation on a homepage or transmits the situation to the terminals 300 of the transparent experts registered and managed in advance to allow the translation experts to perceive this. Accordingly, the transparent experts apply for translation based on the types and contents of the works, and the information on the artists registered in the management platform 100 through the terminals 200. (S2)

The writer refers to information (the past translation records, the foreign language abilities, histories, and percentages of royalties) on the plurality of translation experts who applies for the translation to select a translation expert, and notify the management platform 100 of the fact through the terminal 200. (S3)

Accordingly, the management platform 100 sends a work that is to be translated to the terminal 300 of the selected translation expert, and the translation expert proceeds translation.

If the translation is completed (S4), the translation expert registers the completed translation through the terminal 300, and starts electronic publication and promotion. (S5) At the same time, it is notified of the portal site 400.

Then, the completed translation may be transmitted to the terminal 200 of the writer at the same time.

If the electronic publication and promotion of the translation work by the management platform 100 starts, the portal site 400 notices the translation work and invites readers. (S6) Thus, the translation work is bought by the invited readers.

The profit of the sold translation work is distributed based on a contract for distribution of a profit of the management platform 100 and the portal site 400. (S7)

Another embodiment of the inventive concept will be described.

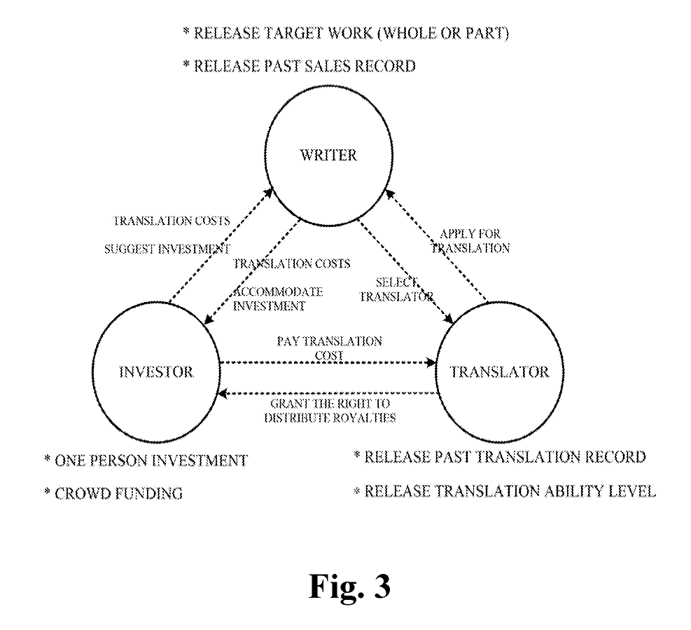

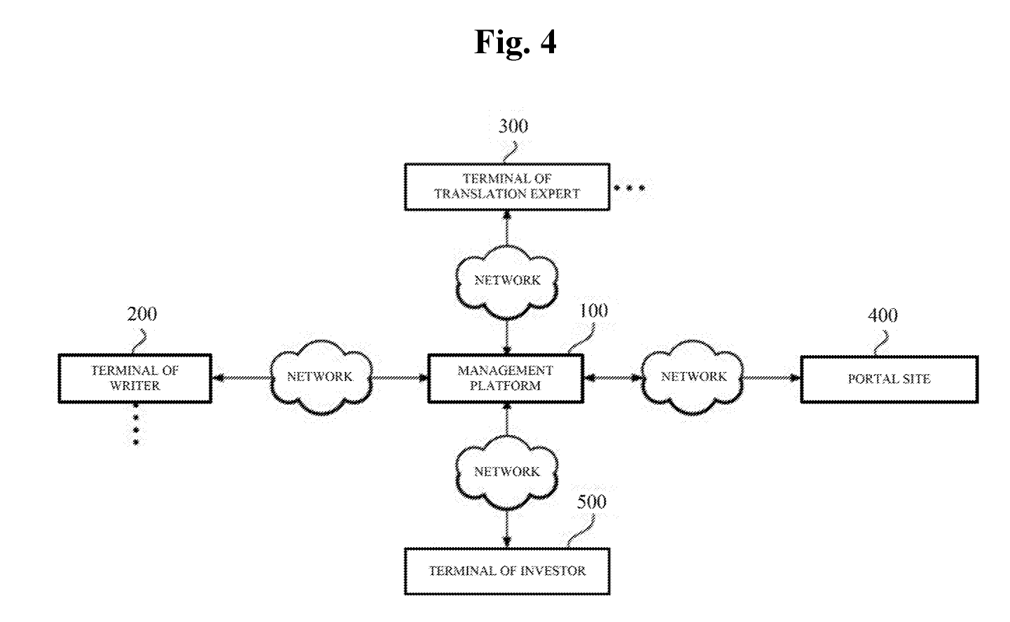

FIG. 3 is a conceptual view of an online profit distributing system in accordance with translation and publication according to another embodiment of the inventive concept, the online profit distributing system including an investor. FIG. 4 is a system diagram technically illustrating FIG. 2.

The operation of the translator (translation expert) is the same as the process before the distribution of the royalties in FIG. 1, an investor invests translation costs, and all or a portion of a royalty distribution sum that was agreed in advance is payed to the investor.

The investor may receive sales records and sales profits of previous works of writers of works registered in the management platform and whether similar works in the same genres as those of the registered works hits from the management platform such that the works are compared and selected.

In FIGS. 3 and 4, a platform operator and a portal site are not illustrated.

The investor, the writer, and the translator are connected to the platform operator and the portal site is connected to the platform operator such that a profit is distributed.

If a work is registered in the management platform 100 through the terminal 200, the management platform 100 that recognized the situation reports the fact.

Accordingly, the investor who perceived this supports an investment for the translation costs to the management platform 100 through the terminal 500. The item is transmitted from the management platform 100 to the terminal 200 of the writer such that the writer perceives this.

Then, if the translator receives translation costs, the translator receives the translation costs in advance to report that the royalty profit corresponding to the translator is allocated to the investor, and a translator is selected from the translation applicants who received this such that translation proceeds.

In this way, the writer may report that he or she has an investor for his or her work such that the excellency and success of the work may be approved, the translator may prefer a condition by which translation costs that is more fixed than the uncertain royalties, and the investor may have a good opportunity of gaining a profit only with an discerning eye for selecting a work without directly writing or translating a work.

However, investment for translation costs by the investor may be made without approval of the writer. That is, if the investor suggests investment of the translation costs for the registered work to the management platform 100 through the terminal 500, the management platform 100 that perceived this may accommodates the investment and the investment may be applied later when the royalties of the writer, the translator, and the investor are distributed.

Of course, it may be preferable that the writer knows whether his or her work is invested or not. This may not only prevent an objection from being issued when the royalties are distributed later but also make the writer proud of himself or herself while thinking that the work is invested due to its high value.

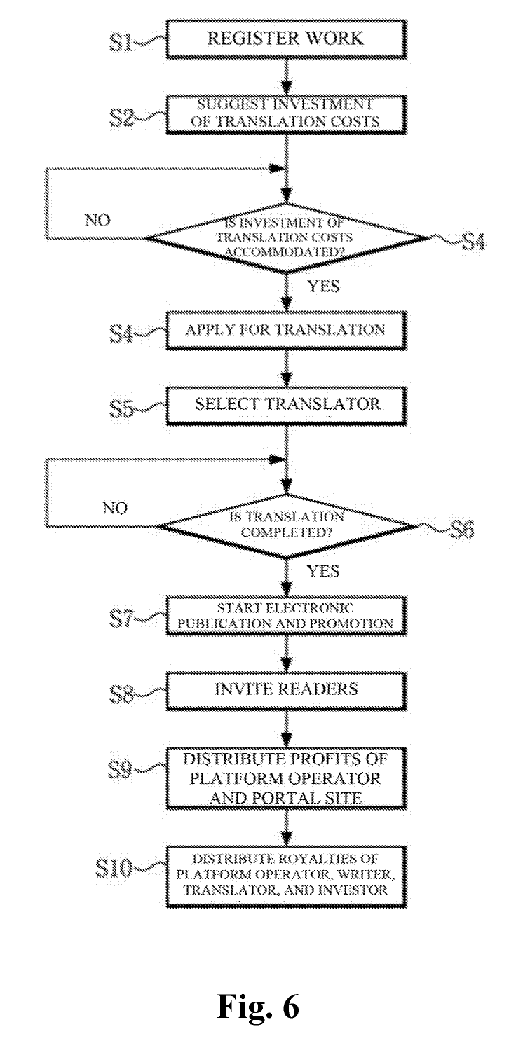

In FIG. 6, in anther embodiment of the inventive concept that performs the operations, the operations after step S4 are performed as illustrated in FIG. 5.

That is, if the writer registers a work desired by him or her in the management platform in step S1, the investor suggests investment of translation costs for the registered work through the terminal 500. (S2)

Accordingly, in step S3, the writer, the investor, and the platform operation if necessary consult each other to accommodate the investment.

Thereafter, the translation proceeds and the publication, the promotion activity, and distribution of a profit are as illustrated in FIG. 6.

Meanwhile, although the management platform, the writer, the translator, and the investor distribute royalties in step S10, the translator may be exempted from the distribution of the royalties if the investor makes a contract with the translator that the translation costs invested by the investor are payed to the translator in advance as described above.

What is claimed is:

1. An online profit distributing system in accordance with translation and publication, the online profit distributing system comprising:
a management platform that registers a work in association with a writer, a translator, and a portal site, translates the work, manages publication, promotion, and sales of the translated work, and manages distribution of a profit to the writer, the translator, and the portal site;
wherein the management platform is configured to:
manage a writer terminal in which the work is registered;
request a translation on the work registered in the management platform from a translator terminal through the writer terminal and receive a translation from the translator terminal;
receive a request for selecting a work that is suitable for performance of translation by the translator from the one or more registered works, from the translator terminal; and
invite readers for the translation after the translation by the translator is completed and perform sales of the translation in association with a portal site, and
wherein the management platform and the portal site share a profit for the sales or subscription of the translation generated by the portal site.

2. The online profit distributing system of claim 1, wherein the management platform is configured to:
receive a request for investment from an investor terminal that supports translation costs for the work registered in the management platform; and
manage distribution of the profit of the translation, wherein a portion of the profit is distributed to an investor.

3. The online profit distributing system of claim 2, wherein the management platform is configured to:
receive at least one of a past translation record, a translation ability, a percentage of royalties intended to be distributed as translator information from the translator terminal; and
provide the translator information to the writer terminal for comparison of the translator by the writer.

4. The online profit distributing system of claim 3, wherein when a plurality of translators apply for the translation, a specific translator is selected based on the translator information of the translators from the writer terminal.

5. The online profit distributing system of claim 4, wherein the management platform provides a promotion activity through at least one of an SNS, a blog, and an internet cafe.

6. The online profit distributing system of claim 3, wherein the translator information further comprises agreement of advanced payment of translation costs.

7. The online profit distributing system of claim 4, wherein the management platform is configured to:
receive a request from the investor terminal, and provide writer information including at least one of sales records and sales profits of previous works of writers of works registered in the management platform and whether similar works in the same genres as those of the registered works from the management platform hits, to the investor terminal, and
wherein the writer information is used for selecting a work that is an investment target by the investor.

8. The online profit distributing system of claim 7, wherein the management platform is configured to:
if receiving an investment of translation costs for a specific work from the investor terminal, provide an investment support result to the writer terminal.

9. The online profit distributing system of claim 8, wherein the management platform is configured to:
when investment of translation costs of the registered specific work by the investor is supported without an approval of the writer, accommodate the investment support result received from the investor terminal as it is, apply the invest support result later when the royalties of the writer, the translator, and the investor are distributed.

10. The online profit distributing system of claim 8, wherein the management platform is configured to:
pay translation costs to the translator in advance through the investment support result, and provide a profit of the translator, among the royalty profit of the translation, to the investor.
